(19) United States
(12) Patent Application Publication
(10) Pub. No.: US 2004/0160860 A1
(43) Pub. Date: Aug. 19, 2004

(54) Magneto-optical recording/reproducing method and apparatus

(76) Inventors: Hongwei Song, Pittsburgh, PA (US); Jingfeng Liu, Shrewsbury, MA (US); Vijayakumar Bhagavatula, Upper St. Clair, PA (US); Akira Inaba, Abiko (JP); Katsusuke Shimazaki, Ibaraki (JP); Norio Ota, Ibaraki (JP)

Correspondence Address: KIRKPATRICK & LOCKHART LLP, 535 SMITHFIELD STREET, PITTSBURGH, PA, 15222, US

(21) Appl. No.: 10/369,360

(22) Filed: Feb. 18, 2003

(51) Int. Cl. G11B 11/00

(52) U.S. Cl. 369/13.06

(57) ABSTRACT

Recording/reproducing methods and apparatuses for a magneto-optical recording medium are disclosed. The magneto-optical recording medium may include a recording layer in which information can be recorded and a reproducing layer to which information in the recording layer can be transferred. According to one embodiment, the method includes encoding the data to be recorded/reproduced with a low-density parity check code, writing the encoded data to the recording layer of the magneto-optical recording medium, transferring the encoded data from the recording layer to the reproducing layer, and decoding the encoded data from the reproducing layer.

### BACKGROUND OF THE INVENTION

In recent years, with the development of information technology and an increase in the amount of information, optical memories on which a large amount of information can be recorded have been used. The optical memories include magneto-optical recording media, which have been actively developed. It is possible to rewrite the information recorded on the magneto-optical recording media. It has been requested that magneto-optical recording media be larger in storage capacity to record a large amount of information, such as time-varying or dynamic picture image data or voice data. In order to meet this request, various technologies for higher density of magneto-optical recording media have been developed. One of the technologies is to narrow the track pitch of a magneto-optical recording medium and form minute magnetic marks in the recording layer of the medium by narrowing the recording light spot or shortening the wavelength of the light. The size of the recorded magnetic marks is quite smaller than the diameter of the reproducing light spot. Therefore, the minute magnetic marks positioned within the reproducing light spot need to be reproduced discriminately.

The magnetic super resolution (MSR) technology attracts attention because it is a method for independently reproducing magnetic domains smaller than the diameter of a reproducing laser beam spot. A magneto-optical recording medium for MSR reproduction includes a recording layer and a reproducing layer. At the time of reproduction, magnetic domains of the recording layer are transferred to the reproducing layer. The magnetic characteristic of the reproducing layer is adjusted in such a manner that, when this layer is irradiated with the reproducing laser beam, its domains, each having a temperature equal to or higher than, or equal to or lower than a predetermined temperature, may function as magnetic masks. At the time of reproduction, the magnetic masks are effective as if the reproducing light spot were effectively smaller in size. There are known three types of MSR reproduction according to the region for detection of the reproduced signal or signals in the reproducing light spot. The types of MSR reproduction are front aperture detection (FAD), central aperture detection (CAD), and rear aperture detection (RAD).

A magneto-optical recording medium of the CAD type includes a recording layer that is a perpendicular magnetic film and a reproducing layer. The reproducing layer is an in-plane magnetic film at room temperature, but it is a perpendicular magnetic film at a temperature above a predetermined (critical) temperature. Because such a magnetic characteristic of the reproducing layer enables a magnetic mask to be formed, it is possible to reproduce information from the recording medium without applying an external (reproducing) magnetic field. Accordingly, a magneto-optical recording medium of the CAD type is advantageous in terms of drive power-saving etc. as compared with the other types, which require the application of a reproducing magnetic field. As an example, U.S. Pat. No. 5,278,810 discloses a CAD type magneto-optical recording medium including a recording layer and an auxiliary magnetic layer. The auxiliary magnetic layer has a lower coercive force at room temperature, and has a higher curie temperature than the recording layer. Magnetization of the auxiliary magnetic layer enables overwrite recording of the light intensity modulation manner.

The technology of forming stable record marks in the recording layer of a magneto-optical recording medium is important because it is related to the quality of the signals reproduced from the medium. As an example, Japanese Patent application no. 11-25535 discloses light pulse and magnetic field modulation as a method for recording stable record marks on a magneto-optical recording medium. The light pulse and magnetic field modulation manner involves irradiating a magnetic recording medium with optical pulses to discontinuously heat it, heating the magnetic recording film of the recording medium to the curie temperature of this film or higher. The heating makes the recording film nonmagnetic to erase the old information in the recorded magnetic domains of this film. Then, the heated recording film cools down to the Curie temperature or lower. During this cooling process, the coercive force of this recording film becomes larger. The cooled recording film is magnetized in the direction along an external recording magnetic field at the temperature at which the coercive force exceeds the magnetic field intensity. If the optical pulses are radiated in synchronism with a reference clock, the cooling process of the recording film and the change in coercive force are constant with respect to the clock. The size of the recording magnetic domains depends on the magnetic field intensity. Normally, a recording magnetic field of constant intensity is applied to the recording medium to record marks of the same size on it. The polarities of the magnetic field represent recording information bits “0” and “1”, which correspond to the upward and downward directions of magnetization respectively of the perpendicular magnetic film of the recording medium. It is shown that this technology makes it possible to obtain stable record marks by eliminating defects in the magnetic modulation system.

In order to record minute magnetic domains on the recording layer of a magneto-optical recording medium at high speed, it is necessary to modulate the recording magnetic field at high speed. For this purpose, a floating magnetic head is used which includes a solenoid coil and utilizes an air current generated by rotation the magneto-optical recording medium. The magnetic head enables the magnetic recording film of the recording medium and the magnetic head to be close to each other. This makes it possible to form recording magnetic domains in the recording layer even with a small magnetic field generated by the magnetic head. Consequently, the drive current for the magnetic head can be small, and the recording magnetic field can be modulated at high speed.

The use of signal processing technology is also known as a method of recording information with high density on a magneto-optical recording medium. Usually, as the recording density of a magneto-optical recording medium rises, the interference between the recorded codes becomes larger, and the decoding performance of the medium deteriorates. In order to prevent the decoding performance of a magneto-optical recording medium from deteriorating, a partial response maximum likelihood (PRML) system, which is a combination of a partial response system and a maximum likelihood decoding system, is used. The partial response system realizes a pseudo multi-value level by positively utilizing the interference between waveforms. The maximum likelihood decoding system decodes data with maximum likelihood decoding by means of the repetition characteristic of a convolution code. The PRML system finds out the signal series that maximizes the likelihood of partial response of a reproduced signal by means of Viterbi decoding.

PRML systems positively utilize the interference between waveforms. The more positively the effect of this interference is utilized, the higher the recording density is. However, if the length of the record marks is shortened for higher recording density, the signal to noise ratio (SNR) of the reproduced signals falls remarkably. As shown in FIG. 7, for example, if the mark length is 0.17 μm or less, the number of errors increases, and even the PRML system has not made it possible to reproduce some of the recorded signals.

In particular, if a CAD type magneto-optical recording medium is used, random errors are liable to occur, and the decrease in SNR caused by the interference between waveforms can cause many random errors. The random errors are considered to occur by the following causes. Magnetic super resolution reproduction involves irradiating the reproducing layer of a magneto-optical recording medium with reproducing light to produce a heat distribution in a light spot, and utilizing this distribution to control the region of the reproducing layer to which the magnetic domains of the recording layer of the medium are transferred. Therefore, the reproducing layer is formed of magnetic material with small coercive force. Random errors are considered to occur because the reproducing layer is liable to be influenced by external environments, such as a change in the output from the laser light source or an unintended external magnetic field. There is an MSR magneto-optical recording medium of the magnetostatic coupling type, which includes a non-magnetic layer between a reproducing layer and a recording layer. This recording medium is also liable to be influenced by external environments. This is considered to cause random errors. However, the development of a new medium free of the influence of external environments is time-consuming and costly, and is accordingly undesirable.

Therefore, there exists a need in the art for a recording/reproducing technique for a magneto-optical recording medium that can reliably reproduce a recorded signal even with low SNR due to minute record marks.

### BRIEF SUMMARY OF THE INVENTION

In one general aspect, the present invention is directed to a recording/reproducing method for a magneto-optical recording medium. According to one embodiment, data to be written in a magneto-optical recording medium is encoded by an LDPC encoder. The encoded data is recorded on the magneto-optical medium. The reproduction of the recorded data involves reading the data from the medium and decoding the read data by means of an LDPC decoder. The decoding operation may utilize soft iterative decoding such as, for example, according to the sum-product algorithm. By recording and reproducing information with an LDPC code, it is possible to obtain a high correcting effect, which decreases random errors, even at low a signal-to-noise ratio (SNR), making it possible to reliably reproduce the information.

In another general aspect, the present invention is directed to a recording/reproducing apparatus for a magneto-optical recording medium. According to one embodiment, the apparatus comprises a coding system for encoding the information to be recorded/reproduced with a low-density parity check code and means for writing the encoded data to the recording layer of the magneto-optical recording medium. The apparatus may further include means for decoding the encoded data.

### DESCRIPTION OF THE DRAWINGS

Embodiments of the present invention are described herein in conjunction with the following figures, wherein:

FIG. 1 schematically shows a CAD type magneto-optical recording medium for magnetic super resolution used in one embodiment of the present invention;

FIGS. 2(A) and 2(B) show recording/reproducing apparatuses according to embodiments of the present invention;

FIG. 3 schematically shows the projective optical system and reflective optical system of the optical head of the recording/reproducing apparatus according to one embodiment of the present invention;

FIG. 4 shows the relationships between the reference clock, optical pulses, recording information code, recording magnetic field polarity inversion timing, recording magnetic field, recording magnetic domains (record marks) and reproduced signal on the light pulse and magnetic field modulation recording system according to one embodiment of the recording/reproducing apparatus of the present invention;

FIG. 5 is a block diagram of a code processor for use with an LDPC code according to one embodiment of the present invention;

FIG. 6 shows the results of the soft decision decoding before the LDPC decoding for one embodiment of the present invention;

FIG. 7 is a graph of Srms/Nrms with respect to the mark length of the shortest record mark;

FIG. 8 shows the structure of a low-density code matrix;

FIG. 9 shows the results of the soft decision decoding and LDPC decoding in a case where information was recorded and reproduced on the NRZI modulation system with the minimum mark length being 0.15 μm; and

FIG. 10 shows the results of the soft decision decoding and LDPC decoding in a case where information was recorded and reproduced on the RLL (1, 7) modulation system with the minimum mark length being 0.18 μm.

### DETAILED DESCRIPTION OF THE INVENTION

According to a first aspect of the present invention, there is provided a recording/reproducing method for a magneto-optical recording medium including a recording layer in which information can be recorded and a reproducing layer to which the information in the recording layer can be transferred. The method is characterized in that information may be recorded and reproduced by coding with a low-density parity check code.

According to one embodiment, the recording/reproducing method includes the step of writing data on the magneto-optical recording medium by coding of the data with the low-density parity check code. More specifically, the method includes the steps of encoding user data with the parity check code and recording the encoded data on the recording medium. The method may also include the step of reproducing the recorded information by decoding the recorded data repeatedly with the parity check code. The decoding operation may employ soft iterative decoding according to, for example, a sum-product (sometimes referred to as a message passing) algorithm, as described in, for example, Kschischang et al., “Factor Graphs and the Sum-Product Algorithm,” IEEE Transactions on Information Theory, 2001, which is incorporated herein by reference. Low-density parity check (LDPC) codes are described in detail in R. G. Gallager, “Low-Density Parity Check Codes,” MIT Press, Cambridge, Mass. 1963, which is incorporated herein by reference.

An LDPC code is a code specified by a matrix most of which is bits “0” and a relatively small part of which is bits “1”. In other words, an LDPC code is a linear code defined by a sparse matrix, which includes a very small number of nonzero elements “1”. LDPC codes are effective in correcting random errors. LDPC codes make it possible to accurately reproduce information even with low reproduced SNR.

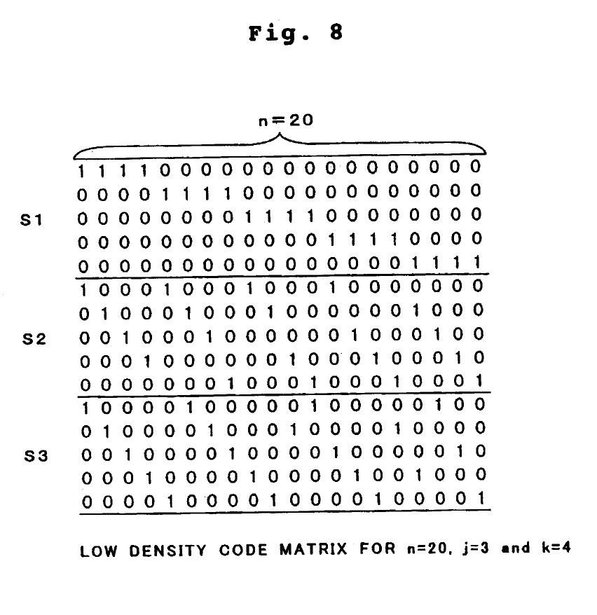

With reference to FIG. 8, a method for forming an LDPC code parity check matrix is explained. The matrix is defined as an (n,j,k) matrix where “n”, “j” and “k” are the number of columns of the matrix, the number of bits “1” of each column and the number of bits “1” of each line, respectively. The number of lines of the matrix is nj/k. FIG. 8 shows a low-density code matrix for n=20, j=3 and k=4. An (n,j,k) low-density code matrix is divided into “j” sub-matrices (partial matrices). Each column of each sub-matrix includes one bit “1”. The low-density code matrix shown in FIG. 8 for j=3 is divided into 3 sub-matrices S1, S2 and S3. The first line of the first sub-matrix S1 consists of “k” (4) consecutive bits “1” and “n-k” (16) bits “0”. The second line of this sub-matrix S1 is formed by the k-bit (4-bit) cyclic permutation of the first line to the right. Likewise, the third line of the sub-matrix S1 is formed by the k-bit cyclic permutation of the second line to the right. In this way, each line of the sub-matrix S1 is formed.

The second through j^{th} sub-matrices S2-Sj are formed by the column permutation of the first sub-matrix S1. The column permutation for each of the sub-matrices S2-Sj may be selected independently at random. In this way, the LDPC code parity check matrix can be formed.

The above describes one manner of constructing a parity check matrix. It should be noted that there are many other ways to construct parity check matrices, each of which are within the contemplation of the present invention.

According to one embodiment, the magneto-optical recording medium used with the recording/reproducing method of the present invention may be a magneto-optical recording medium according to the magnetic super resolution (MSR) technology. In particular, this medium may be the CAD type magneto-optical recording medium. As stated already, the CAD type magneto-optical recording medium is liable to cause random errors. Accordingly, utilizing a LDPC code, as per one embodiment of the present invention, makes it possible to reproduce recorded information from the CAD type magneto-optical recording medium even if the information is reproduced in lower SNR than the conventional technique. In addition, there may be a case where, because record marks are smaller than the conventional marks, it is not possible to reproduce information even with a PRML system, which positively utilizes the interference between waveforms. Even in such a case, the LDPC code makes it possible to reliably reproduce information, and to consequently record information with higher density than conventional technique.

According to one embodiment of the recording/reproducing method, the magneto-optical recording medium may be a CAD type magneto-optical recording medium. When the CAD type magneto-optical recording medium is irradiated with reproducing light during the reproduction of information, the irradiation forms a light spot in the recording layer of this medium. The information recorded in the recording layer is transferred from a high temperature area near the center of the light spot in this layer to the reproducing layer. In one embodiment, therefore, the reproducing layer may have a magnetic characteristic such that the direction of magnetization of this layer changes from in-plane magnetization to perpendicular magnetization at a predetermined (critical) temperature that is in the range from room temperature to the curie temperature of the layer.

When the magneto-optical recording medium is irradiated with recording light as part of the process of recording information, the reproducing layer of this medium may have a magnetic characteristic such that its perpendicular magnetic anisotropic energy and anti-magnetic field energy are substantially equal. When the recording medium is irradiated with the recording light, the magnetization of the reproducing layer is unstable and liable to be either perpendicular or in-plane. This makes it possible to record information on the recording medium even with a recording magnetic field of low intensity. Consequently, it is possible to improve the transfer rate by increasing the recording frequency of the magnetic head, and to reduce the power consumption of the head.

The recording/reproducing methods of the present invention make it possible to form minute record marks in the recording layer of a magneto-optical recording medium and to record a great amount of information on an existing magneto-optical recording medium only by means of the signal processing of data to be recorded. It is consequently possible to reduce the cost of developing new media for high-density recording.

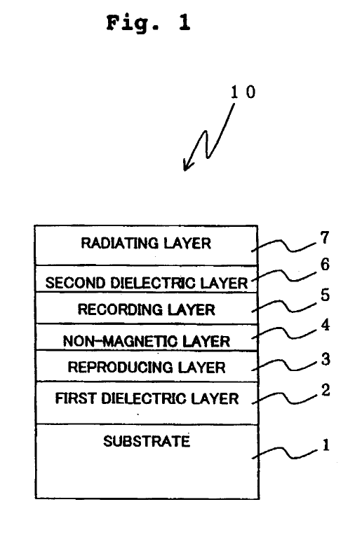

The recording/reproducing method may, as described previously, use a CAD type magneto-optical disk according to the magnetic super resolution technology as the magneto-optical recording medium. FIG. 1 is a schematic cross section of the recording medium (e.g., disk.) 10 according to one embodiment. The medium 10 includes a substrate 1, which is laminated with a first dielectric layer 2, a reproducing layer 3, a nonmagnetic layer 4, a recording layer 5, a second dielectric layer 6 and a radiating layer 7 in order.

The substrate 1 may have a thickness of approximately 0.6 mm and may be formed of polycarbonate. One side of the substrate 1 may be formed with a guide groove, a prepit row where a track address etc. are recorded, and another preformat pattern. The layers 2-7 may be formed on this side of the substrate 1.

The first dielectric layer 2 may have a thickness between 40 nm and 80 nm. This dielectric layer 2 may be formed of material higher in refractivity than the substrate 1. This material may be an inorganic dielectric of SiN. The recording domains formed in the recording layer 5 are transferred to the reproducing layer 3 within a high-temperature opening near the center of a reproducing light spot by means of the temperature distribution produced by the radiation of reproducing light.

The reproducing layer 3 magnetically masks the recording domains in the recording layer 5 at the region outside the opening within the spot. This reduces the effective size of the light spot on the recording medium, improving the reproducing resolution. The reproducing layer 3 may be formed of magnetic material that is in-plane magnetic at room temperature, but perpendicular magnetic at a temperature or a higher temperature. This magnetic material may be GdFeCo. The masking area and the opening of the reproducing layer 3 may be in-plane magnetic and perpendicular magnetic, respectively. The reproducing layer 3 may have a thickness between 10 nm and 50 nm.

The non-magnetic layer 4 may be formed of dielectric material such as SiN2, AlN or SiN, or metal such as Al, AlTi, Au, Cu, AuAl or AgAl, or be a laminate of such dielectric material and metal. The nonmagnetic layer 4 may have a thickness between 5 nm and 20 nm. Information can be recorded as a state of magnetization in the recording layer 5. The recording layer 5 may be formed of TbFeCo, DyFeCo or TbDyFeCo and may have a thickness between 30 nm and 60 nm.

The second dielectric layer 6 may be an inorganic dielectric of, for example, SiN and may have a thickness between 10 nm and 50 nm. The radiating layer 7 may be formed, for example, of Al, AlTi, Au, Cu, AuAl or AgAl and may have a thickness between 30 nm and 60 nm. The layers 2-7 may be formed in order by sputtering on a magnetron sputtering apparatus (not shown). Thus, the magneto-optical medium 10 having a laminated structure as shown in FIG. 1 may be produced.

According to a second aspect of the present invention, there is provided a recording/reproducing apparatus used for a magneto-optical recording medium including a recording layer in which information can be recorded and a reproducing layer to which information in the recording layer can be transferred. The recording/reproducing apparatus comprises, according to one embodiment, a coding system for encoding information with a low-density parity check code and means for writing/recording the encoded data to the recording layer of the medium. The recording/reproducing apparatus of the present invention may implement the recording/reproducing method described previously. Accordingly, this recording/reproducing apparatus can densely record information on the magneto-optical recording medium and reliably reproduce the recorded information.

A recording/reproducing method according to one embodiment of the present invention is described below with reference to the accompanying drawings, but it should be recognized that the invention is not limited to the illustrated embodiment.

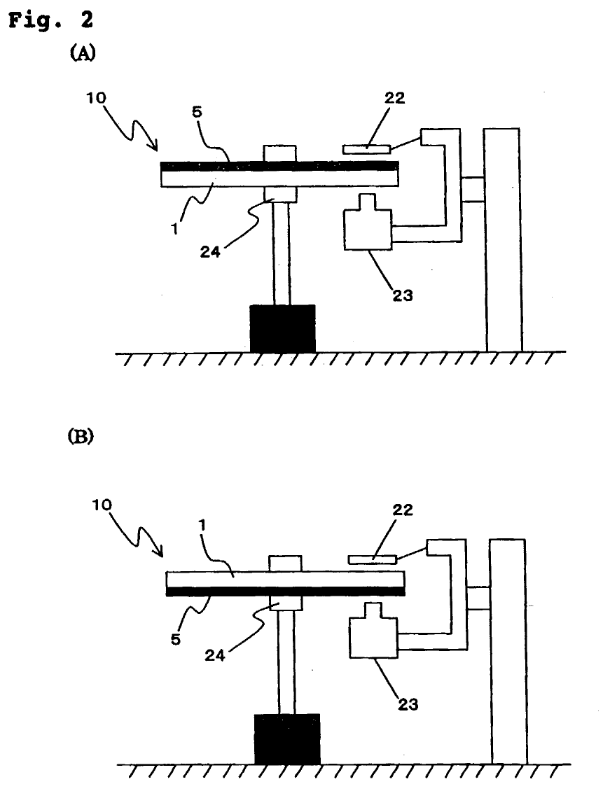

FIGS. 2(A) and 2(B) schematically show the structure of the recording/reproducing apparatus according to one embodiment of the present invention. As shown in FIGS. 2(A) and 2(B), the recording/reproducing apparatus includes a magnetic head 22 and an optical head 23, which are positioned on opposite sides of the magneto-optical medium 10. Alternatively, the two heads 22 and 23 could be combined into an integral magneto-optical head, which may be positioned just over the magneto-optical medium 10. The magneto-optical medium 10 mounted on the recording/reproducing apparatus may be rotated at a predetermined speed by a spindle 24.

FIG. 2(A) shows the magneto-optical medium 10 mounted on the recording/reproducing apparatus in such a manner that the recording layer 5 and the transparent substrate 1 are adjacent to the magnetic and optical heads 22 and 23, respectively. In this case, the light from the optical head 23 is incident on the side of the medium 10 that is adjacent to the substrate 1. FIG. 2(B) shows the medium 10 mounted on the recording/reproducing apparatus in such a manner that the transparent substrate 1 and the recording layer 5 are adjacent to the magnetic and optical heads 22 and 23, respectively. In this case, the light from the optical head 23 is incident on the side of the medium 10 that is adjacent to the recording layer 5.

The magnetic head 22 may be controlled in such a manner that its magnetic field generator is spaced at a predetermined distance from the adjacent surface of the magneto-optical medium 10. Alternatively, the magnetic head 22 could be controlled in such a manner that its magnetic field generator might be in direct contact with the adjacent surface of the medium 10. One method for spacing the field-generating surface of the magnetic head 22 and the adjacent surface of the medium 10 from each other is to levitate or float this head 22 over the medium 10 by means of the airflow produced by the rotation of the medium 10. Another method is to hold the magnetic head 22 in position by supporting it on a supporting arm (not shown). As stated already, the optical and magnetic heads could be combined into an integrated magneto-optical head. The optical head of this magneto-optical head may include a condensing lens (now shown). The condensing lens may be spaced at a constant distance from the magneto-optical medium 10 by a focusing servo and controlled radially of the medium 10 by a tracking servo. This enables the position of the magnetic head relative to the recording layer 5 of the magneto-optical medium 10 to be vertically and horizontally constant.

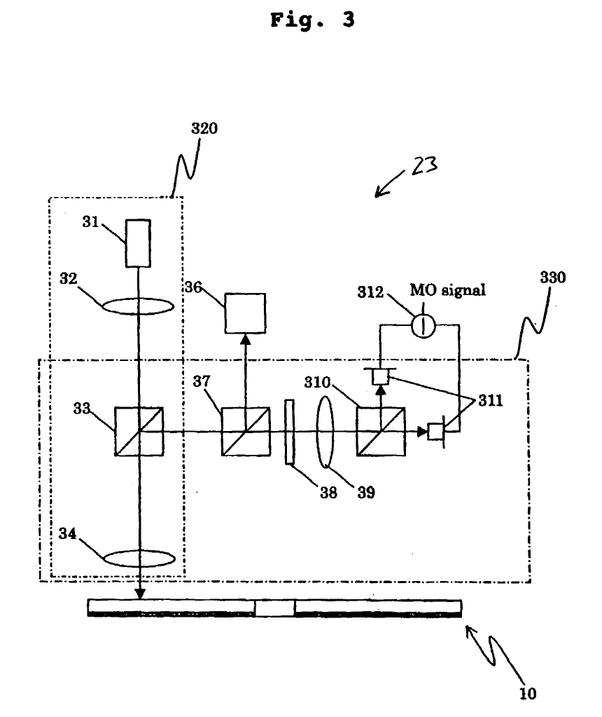

As shown in FIG. 3, the optical head 23 may include a projecting optical system 320 and a reflecting optical system 330. The projecting optical system 320 may consist of a semiconductor laser 31, a collimator lens 32, a beam splitter 33 and an objective lens 34. The semiconductor laser 31 may emit diffused light, which can be converted into a parallel beam (parallel beams) by the collimator lens 32. The beam splitter 33 can separate the beams incident on and reflected by the magneto-optical medium 10. The objective lens 34 can focus the parallel laser beam from the collimator lens 32 on the recording layer 5 of the medium 10.

The reflecting optical system 330 may consist of the objective lens 34 and the beam splitter 33 (which are common to both optical systems 320 and 330), a second beam splitter 37, a half-wave plate 38, a detecting lens 39, an analyzer 310 and photodetectors 311. The second beam splitter 37 can direct part of the reflected beam from the magneto-optical medium 10 to a light spot control signal detector 36. The half-wave plate 38 can adjust the plane of polarization of the reflected beam from the medium 10. The detecting lens 39 can condense the reflected beam from the half-wave plate 38 onto the photodetectors 311. The analyzer 310 may split the reflected beam from the detecting lens 39 into an s-polarized component and a p-polarized component. The signals output from the photodetectors 311 may be input to a differential amplifier 312, which outputs a reproduced signal through its output terminal.

The objective lens 34 may mounted on an actuator (not shown). The signal output from the light spot control signal detector 36 may adjust the distance between the objective lens 34 and the recording layer 5 of the magneto-optical medium 10 in such a manner that the incident beam is always condensed on the recording layer 5.

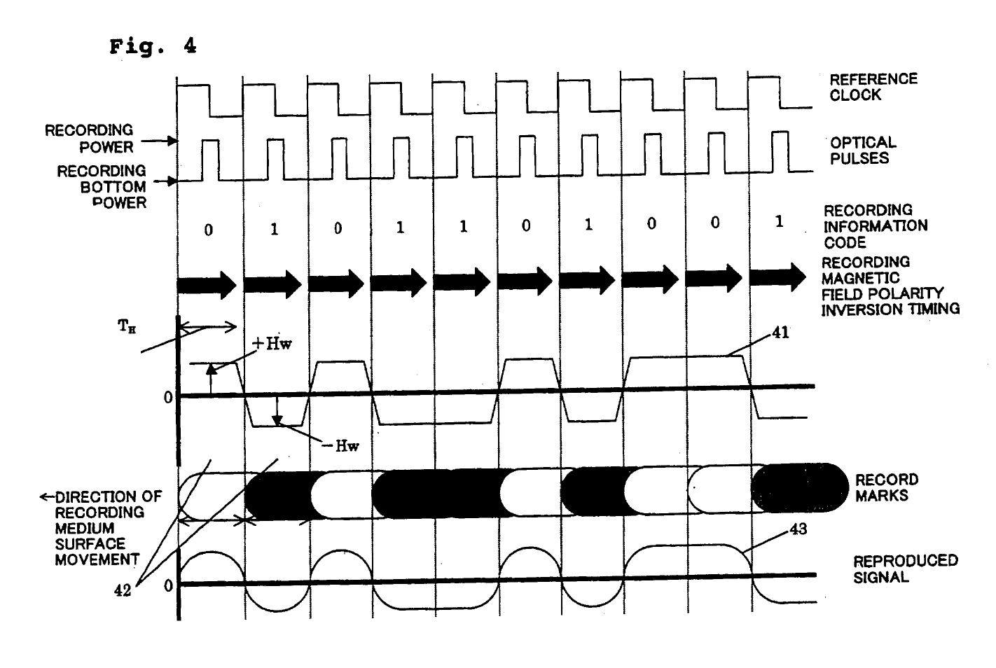

The recording mode of the recording/reproducing apparatus may rely upon the light pulse and magnetic field modulation manner. FIG. 4 conceptually shows a light pulse and magnetic field modulation recording system. During recording, the semiconductor laser 31 irradiates the magneto-optical medium 10 with optical pulses in synchronism with a reference clock to discontinuously heat the medium 10. The magnetic head 22 applies a recording magnetic field 41 to the irradiated area of the magneto-optical medium 10 at a timing of TH with respect to the reference clock. The magnetic field 41 may be polarized to represent a recording information code and may have an intensity of Hw. This forms recording information as magnetic domains magnetized upward and/or downward in the recording layer 5 of the medium 10. The marks (domains) corresponding to the recording information bits “1” and “0” may be equal to each other in linear length 42. As a result, each zero-crossing interval of the reproduced signal 43 may be an integral number of times larger than the reference clock interval. The reproduced signal 43 is an electric signal generated by the optical head 23 converting the magneto-optical effect of the recording medium 10. Accordingly, the signal transformation points of the original and reproduced signals may coincide on the time axis.

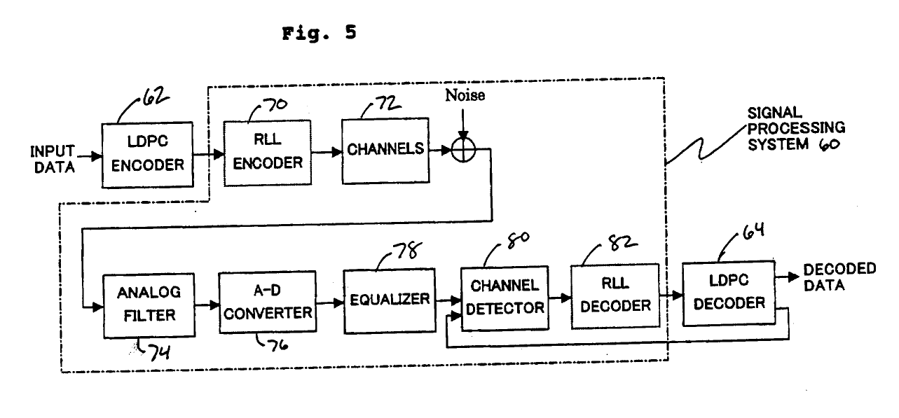

When information is recorded on and reproduced from the magneto-optical medium 10, signals may be processed as follows. FIG. 5 is a block diagram of a code processor for use with an LDPC code according to one embodiment of the present invention. As shown in FIG. 5, the code processor may consist of a signal processing system 60, an LDPC encoder 62 and an LDPC decoder 64. The processing system 60 may include an RLL (run length limited) encoder 70, channels 72, an analog filter 74, an A-D (analog-digital) converter 76, an equalizer 78, a channel detector 80 and an RLL detector 82. First, the LDPC encoder 62 may encode user data. The encoded data may, as necessary, be modulated into an RLL code. The coded data is recorded on the medium 10 by the projecting optical system 320 (see FIG. 3). In this manner, data may be recorded on the medium 10.

The recorded data is reproduced as a reproduced signal. The channels 71 and the noise introduction shown in FIG. 5 represent the reproduced signal from the medium 10 generated by the reflecting optical system 330 (see FIG. 3). The analog filter 74 eliminates high frequency noise from the reproduced signal. The signal output from the analog filter 74 is converted into digital data by the A-D converter 76. The digital data is input to the equalizer 78 for waveform equalization, and then to the channel detector 80 for soft decision decoding by means of, for example, the BCJR (Bahl-Cocks-Jeinek-Raviv) algorithm. If the RLL encoder 70 has encoded the output from the LDPC encoder 62, the RLL decoder 82 decodes the signal output from the channel detector 80. The signal output from the channel detector 80 or the RLL decoder 82 is input to the LDPC decoder 64 for repetitive decoding (10 or fewer times in this embodiment) by means of, for example, the sum-product algorithm.

A recording/reproducing apparatus according to an embodiment of the present invention recorded information on and reproduced the recorded information from a magneto-optical medium under the following conditions. The medium was the CAD type magneto-optical disk shown in FIG. 1. The recording laser beam had a wavelength of 658 nm. The objective lens 34 had a numerical aperture NA of 0.6. During recording, the disk was driven to rotate at a linear velocity between 1.8 m/s and 4.8 m/s. While the rotating disk was irradiated with the optical pulses in synchronism with the reference clock, the recording magnetic field 41 was applied to the disk in synchronism with this clock and with magnetic field intensities of Hw0=+Hw and Hw1=−Hw, which correspond to recording information bits “0” and “1” respectively. The field intensities had an absolute value of |Hw|=200 Oe. The polarity of the magnetic field was reversed at the timing of TH with respect to the reference clock. The optical pulses had a recording power between 6 mW and 7 mW, a reproducing power between 1.5 mW and 2 mW, a laser bottom power of 0.2 mW and a duty ratio of 45%. The record mark length was adjusted by changing the linear velocity without changing the reference clock. The modulation systems were the NRZI and RLL (1, 7) types. The signals were processed according to the block diagram of FIG. 5.

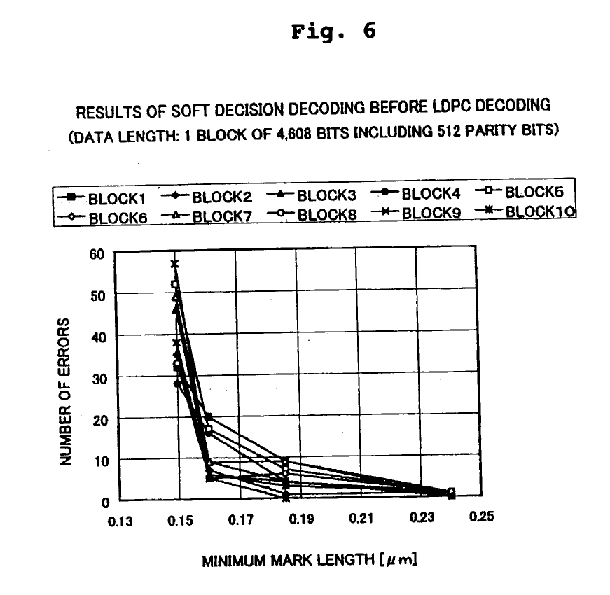

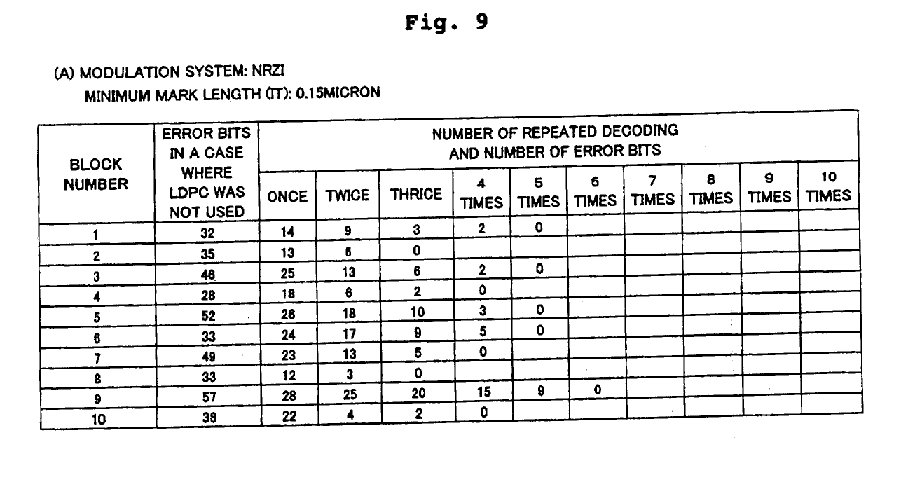

The recorded data had a data length of 10 blocks, each of which is a data row consisting of 4,096 bits of user data and 512 parity bits. First, a case where the NRZI modulation system was used is explained below. The recording reference clock was kept constant at 20 MHz, and the minimum data length was adjusted by varying the recording linear velocity. FIG. 6 shows the results of the conventional soft decision decoding that does not use the LDPC decoding for the minimum mark length. As shown in FIG. 6, the number of errors increases if the minimum mark length is 0.24 or less μm. However, as shown in FIG. 9, it is possible to completely decode the recorded data with a minimum mark length of 0.15 μm by repeating the LDPC decoding 6 times.

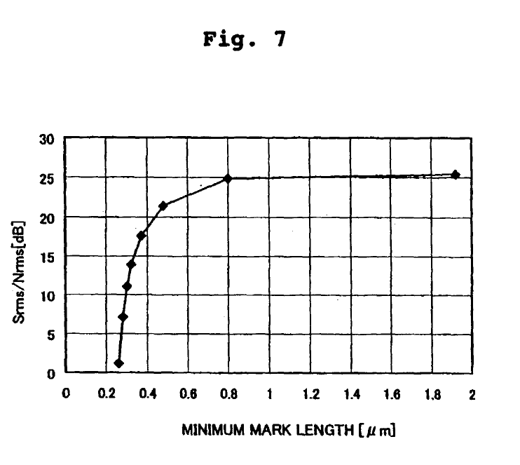

Shortest marks with different polarities were recorded alternately in the recording layer of the magneto-optical recording medium. When the pattern of the alternately recorded marks was reproduced, the SNR was measured. Specifically, the mark length was varied, and the SNR was measured for each of the mark patterns with different mark lengths. FIG. 7 is a graph of the Srms/Nrms for the mark lengths of the alternately recorded marks. As seen from FIG. 7, the Srms/Nrms suddenly decreases due to the interference between waveforms if the minimum mark length becomes shorter than 0.50 μm. Partial response (PR) positively utilizes the interference between waveforms. The more positively this interference is utilized, the higher the recording density can be. However, if the mark length is shortened to increase the recording density, as shown in FIG. 7, the reproduced signal SNR decreases. It is therefore conceivable that a CAD type magneto-optical disk, which is originally liable to cause random errors, causes a large number of errors, as shown in FIG. 6. By recording information on and reproducing information from the CAD type magneto-optical disk with the LDPC code according to the present invention, it is possible to completely decode the recorded data even with low SNR. Because an LDPC code is a decoding form that is very effective in correcting random errors, it enables information to be recorded densely on the CAD type magneto-optical disk.

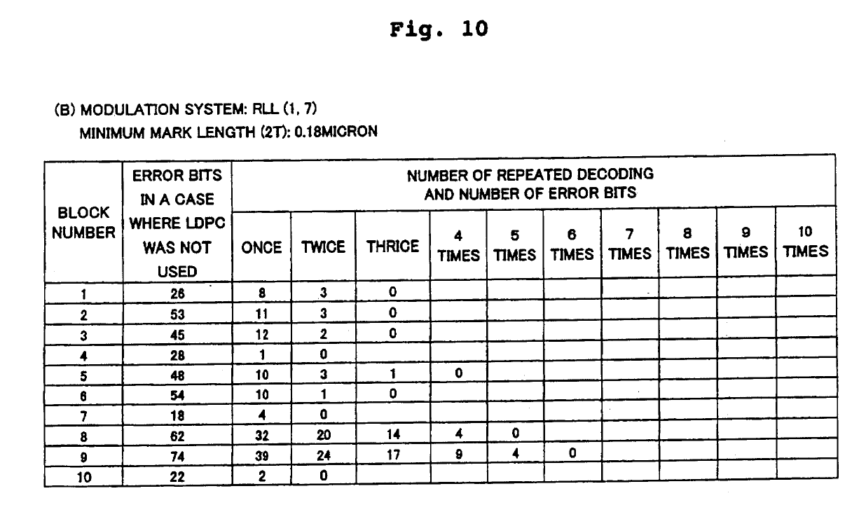

Next, a case where the RLL (1, 7) modulation system was used is explained below. The recording and reproducing conditions were the same as in the case where the NRZI modulation system was used. FIG. 10 shows the results of the soft decision decoding and LDPC decoding in a case where information was recorded and reproduced with the minimum mark length (2T) being 0.18 μm. As shown in FIG. 10, it was possible to decode the recorded data completely by repeating the LDPC decoding 6 times even on the RLL (1, 7) modulation system.

Now, a comparison of recording density is made between the modulation systems. In consideration of the coding rates (NRZI: 0.899 and RLL (1, 7): 0.593) and the track pitch of 0.6 μm, the recording densities on the NRZI and RLL (1, 7) modulation systems are 6.37 Gbits/in² and 7.08 Gbits/in², respectively. This shows that it is possible to further improve the recording density by using the RLL (1, 7) modulation system.

Because the recording/reproducing methods/apparatuses of the present invention use an LDPC code, they have a high ability to correct random errors, and make it possible to reliably reproduce information even with low reproduced SNR. Accordingly, the methods/apparatuses of the present invention are very suitable as recording/reproducing methods/apparatuses for CAD type magneto-optical recording media and other media liable to cause random errors. The recording/reproducing methods/apparatuses of the present invention also make it possible to form minute record marks in the recording layer of a magneto-optical recording medium, and to record a large amount of information on an existing magneto-optical recording medium only by means of the signal processing of data to be recorded. It is consequently possible to reduce the cost of developing new media for high-density recording.

Although the present invention has been described herein with respect to certain embodiments, those of ordinary skill in the art will recognize that many modifications and variations of the present invention may be implemented. For example, the materials disclosed are illustrative, but are not exhaustive. The foregoing description and the following claims are intended to cover all such modifications and variations.

What is claimed is:

1. A recording/reproducing method for a magneto-optical recording medium, the magneto-optical recording medium including a recording layer in which information can be recorded and a reproducing layer to which information in the recording layer can be transferred, the method comprising:
encoding the data to be recorded/reproduced with a low-density parity check code;
writing the encoded data to the recording layer of the magneto-optical recording medium;
transferring the encoded data from the recording layer to the reproducing layer; and
decoding the encoded data from the reproducing layer.

2. The method of claim 1, wherein decoding the encoded data includes soft iterative decoding the encoded data.

3. The method of claim 2, wherein soft iterative decoding the encoded data includes repeatedly decoding the data based on the sum-product algorithm.

4. The method of claim 3, wherein writing the encoded data to the recording layer includes:
irradiating the magneto-optical recording medium with optical energy pulses in synchronism with a reference clock signal; and
applying a magnetic field to the magneto-optical recording medium in synchronism with the reference clock signal.

5. The method of claim 1, wherein transferring the encoded data includes irradiating the magneto-optical recording medium with optical energy.

6. The method of claim 5, wherein irradiating the magneto-optical recording medium with optical energy includes generating a light spot in the recording layer such that encoded information from the recording layer is transferred from a high temperature area of the recording layer near a center of the light spot to the reproducing layer.

7. The method of claim 1, wherein the magneto-optical recording medium includes a CAD-type magneto optical recording medium.

8. The method of claim 7, wherein the direction of magnetization of the reproducing layer changes from in-plane magnetization to perpendicular magnetization at a predetermined temperature that is in a range from temperature to the curie temperature of the reproducing layer.

9. A recording/reproducing method for a CAD-type magneto-optical recording medium, the CAD-type magneto-optical recording medium including a recording layer in which information can be recorded and a reproducing layer to which information in the recording layer can be transferred, the method comprising:
encoding the data to be recorded/reproduced with a low-density parity check code;
writing the encoded data to the recording layer of the magneto-optical recording medium by irradiating the magneto-optical recording medium with optical energy pulses in synchronism with a reference clock signal and applying a magnetic field to the magneto-optical recording medium in synchronism with the reference clock signal;
irradiating the magneto-optical recording medium with optical energy such that a light spot is generated in the recording layer such that encoded information from the recording layer is transferred from a high temperature area of the recording layer near a center of the light spot to the reproducing layer; and
soft iterative decoding the encoded data from the reproducing layer.

10. A recording/reproducing apparatus for a magneto-optical recording medium, the magneto-optical recording medium including a recording layer in which information can be recorded and a reproducing layer to which information in the recording layer can be transferred, the apparatus comprising:
a coding system for encoding the information to be recorded/reproduced with a low-density parity check code; and
means for writing the encoded data to the recording layer of the magneto-optical recording medium.

11. The apparatus of claim 10, wherein the coding system includes a LDPC encoder.

12. The apparatus of claim 10, wherein the coding system further includes a RLL encoder in communication with the LDPC encoder.

13. The apparatus of claim 10, wherein the means for writing the encoded data to the recording layer includes:
a magnetic head oriented for positioning near a surface of the recording medium; and
an optical head oriented for positioning near a surface of the recording medium.

14. The apparatus of claim 13, wherein the optical head includes a projecting optical system for irradiating the magneto-optical recording medium with optical energy pulses in synchronism with a reference clock signal.

15. The apparatus of claim 14, wherein the magnetic head is for applying a magnetic field to the magneto-optical recording medium in synchronism with the reference clock signal.

16. The apparatus of claim 13, wherein the magnetic head and the optical head are integrated to form an integral magneto-optical head.

17. The apparatus of claim 13, wherein the magnetic head and the optical head are oriented for positioning near opposite surfaces of the recording medium.

18. The apparatus of claim 13, wherein the magnetic head includes a floating magnetic head.

19. The apparatus of claim 10, further comprising means for decoding the encoded data.

20. The apparatus of claim 19, wherein the means for decoding the encoded data include an LDPC decoder.

21. The apparatus of claim 19, wherein the means for decoding the encoded data includes means for soft iterative decoding of the encoded data.

22. The apparatus of claim 21, wherein the means for soft iterative decoding the encoded data includes means for decoding the data based on the sum-product algorithm.

23. The apparatus of claim 15, wherein the optical head further includes a reflecting optical system for generating a reproduced signal from the recording medium.

24. The apparatus of claim 23, further comprising a LDPC decoder in communication with the reflecting optical system.

25. The apparatus of claim 24, further comprising a channel detector in communication with the LDPC decoder.

26. The apparatus of claim 10, wherein the magneto-optical recording medium includes a CAD-type magneto optical recording medium.

27. A recording/reproducing apparatus for a CAD-type magneto-optical recording medium, the CAD-type magneto-optical recording medium including a recording layer in which information can be recorded and a reproducing layer to which information in the recording layer can be transferred, the apparatus comprising:
a coding system for encoding the information to be recorded/reproduced with a low-density parity check code;
a data recording system in communication with the coding system, the data recording system including:
a projecting optical system for irradiating the CAD-type magneto-optical recording medium with optical energy pulses in synchronism with a reference clock signal; and
magnetic head is for applying a-magnetic field to the magneto-optical recording medium in synchronism with the reference clock signal;
a reflecting optical system for generating a reproduced signal from the recording medium; and
means for decoding the reproduced signal.

28. The apparatus of claim 27, wherein the means for decoding the reproduced signal includes:
a channel detector for a digitized version of the reproduced signal; and
a LDPC decoder in communication with the channel detector.
